(19) United States
(12) Patent Application Publication
(10) Pub. No.: US 2025/0250655 A1
(43) Pub. Date: Aug. 7, 2025

(54) SELECTIVE REMOVAL OF RADIUM AND ACTINIUM FROM ACIDIC SOLUTION USING COMPOSITE ADSORBENTS

(71) Applicant: Advanced Isotope Technologies, LLC, Mobile, AL (US)

(72) Inventor: Shameem Hasan, Sunrise, FL (US)

(21) Appl. No.: 19/047,468

(22) Filed: Feb. 6, 2025

Related U.S. Application Data
(60) Provisional application No. 63/550,450, filed on Feb. 6, 2024.

(51) Int. Cl. C22B 60/02; B01J 20/02; B01J 20/10; B01J 20/34

(52) U.S. Cl. CPC C22B 60/0295; B01J 20/0211; B01J 20/0214; B01J 20/0218; B01J 20/0259; B01J 20/103; B01J 20/34

(57) ABSTRACT

The present disclosure provides a process for the separation and purification of radium and actinium from acidic solution using composite adsorbents. The process includes preparing polyoxometalates (POMs)-based mesoporous composite metal-infused resins using phosphate recovered from waste buffer solution. The resins are prepared using a modified sol-gel technique to form inorganic composite metal-oxide clusters. Embodiments of the resins include silica-coated composite metal oxide particles, including antimony-vanadium oxide particles, and tungsten-doped mesoporous titanium oxide particles. The resins have differing adsorption affinities for actinium, radium, and other metal ions and may thus be utilized for selectively separating radium and actinium from irradiated thorium targets.

### CROSS-REFERENCE TO RELATED APPLICATIONS

This application claims the benefit of U.S. Provisional Application Ser. No. 63/550,450, filed on Feb. 6, 2024, which is incorporated herein in its entirety by reference.

### FIELD OF THE DISCLOSURE

The present disclosure relates generally to composite adsorbent materials and methods of using such materials for the selective removal of radium and actinium from acidic solution.

### BACKGROUND

Ionizing radiation has received a great deal of interest in radiotherapy due to its ability to interact with soft tissue matter to kill cancer cells [1]. The ionizing radiation such as α, β, and Auger electrons are used in targeted radionuclide therapy (TRT). An alpha (α)-particle is an ionized 4He nucleus with a +2 electric charge. It is relatively heavier than the other subatomic particles such as electrons, neutrons, and protons [2]. The high linear energy transfer (LET) ability of α-particles in soft tissue has drawn attention to the scientific communities for their applications in radiotherapy. Radiotherapy that uses α-radiation emitters is known as targeted alpha therapy (TAT). TAT is a fast-growing treatment for malignant tumors. Several studies have reported that the application of various α-emitting radionuclides in TAT is suitable for maximum cancer cell destruction without excessive damage to the surrounding healthy tissues [1, 3, 4]. A typical alpha particle has a range of 40 to 100 microns in soft tissue. This short range in soft tissue is limited to only a few cell diameters [4]. It has been reported that α-particles exhibit a very high linear energy transfer (LET) with a mean energy deposition of 100 keV/μm of the targeted tissue [5, 6]. This amount of energy is sufficient to cause the death of targeted cells due to the damage of the nucleus of the cell, while negligible toxicity is imparted to the surrounding healthy cells [7, 8, 9]. It has also been reported that a targeted β-particle would have a range of 1-10 mm, and this may increase the damage of normal cells near the targeted cell due to the deposition of a larger amount of β-particle energy [10]. It has been further reported that the combination of α-particles and β-particles may help to increase the therapeutic efficacy for tumor heterogeneity [5]. In addition, the radiolabeling of a monoclonal antibody (mAb) with radionuclides that emit electron capture and Auger electrons may compromise the chelating moiety leading to a major complication [5]. It has also been reported that an α-particle deposits 1500 times more energy per unit path length than a β-particle. Therefore, targeted α-particle based therapy is considered ideal for the treatment of smaller tumor burdens, micrometastatic disease, and disseminated disease [2, 5, 8].

Actinium-225 (t½=9.92 d) is a typical example of an α-emitting radionuclide. Actinium-225 (Ac-225) has six radionuclide daughters that generate multiple α-particles in the decay path to a final stable state Bismuth-209 (Bi-209) [5]. The nuclear properties of Ac-225, such as half-life and decay scheme, are well-suited for its use in targeted alpha therapy (TAT) [3]. Ac-225 is the natural decay product of Th-229. The waste stockpiles containing Uranium-233 is the known source of Th-229 [4]. The Ac-225 can be obtained as a natural decay product from a Th-229/Ac-225 generator system. In Th-229/Ac-225 generator systems, Th-229 is bound to an anion exchange resin. Over the period, Th-229 decays to Ac-225, which may be finally eluted from the column using 8 M nitric acid [10]. The half-life of Th-229 is 7,340 years. Therefore, a very small fraction of Th-229 is converted to Ac-225 and Bi-213 during a one-year period [11]. The source of Ac-225 from Th-229 decay scheme is considered to be a realistic path [6]. However, the amounts of α-radionuclides obtained from this process is not sufficient to meet the current market demand. Several alternative routes have been investigated for the artificial production of larger amounts of Ac-225 [4, 6, 11]. The production of Ac-225 using cyclotrons and linear accelerators are the most important alternative routes. It has been reported that a small quantity of a very pure form of Actinium-225 can be produced from Radium-226 using a cyclotron [12]. The irradiation of Radium-226 can be performed with lower energy (<25 MeV) protons via the reaction ²²⁶Ra(p,2n)²²⁵Ac. The disadvantage of this process includes the lack of routine experience with Ra-226 targets [13]. Another major concern of this process is to handle Rn-222 daughter, a radioactive gas with a half-life of 3.82 days. In a linear accelerator, Actinium-225 can be produced by high-energy (>70 MeV) proton irradiation of a thorium (Th) target via the reaction ²³²Th(p, x)²²⁵Ac[10,14]. It is imperative to note that higher bombardment energies in a linear accelerator can produce a large quantity of Ac-225 but also yield about 400 other radioisotopes [12, 15]. Ac-225 production via the photonuclear reaction [²²⁶Ra(7,n)²²⁵Ra→²²⁵Ac] is considered as another promising route. This photonuclear production process also has the potential to provide a clinically relevant supply of Ac-225 [4].

Radionuclidic purity for Ac-225 refers to the percentage of radioactivity of Ac-225 present in the total radioactivity of the product. For effective utilization of the radioisotope, it must be free of isotopic contamination when it is used for labeling or intravenous administration to humans [16]. Separation and purification of Ac-225 from the fission generated by-product isotopes are very challenging as the chemical properties of these isotopes are very similar to actinide [17]. Another challenge for working with alpha emitters is that they are toxic [8]. Moreover, the limit for allowable removable contamination for alpha emitters is 50 times lower than that of beta emitters [12].

Actinium is a trivalent (3+) ion with ionic radius of 112 pm [18]. It has been reported that the coordination chemistry of Ac (III) is not well-defined primarily due to the lack of stable isotopes that can promote routine chemical studies [5, 18]. The trivalent cation Ac³⁺ has no electrons in its outermost shell (5f0 6d0) [19]. It is reported that both lanthanum (La) and actinium (Ac) are trivalent cations and have similar chemistry [15, 20]. Therefore, La can be used as a nonradioactive surrogate for Ac-225. Under normal conditions, Ac³⁺ adopts the electronic configuration of the noble gas radon (Rn), and La³⁺ adopts the electronic configuration of xenon (Xe) [21]. It has been reported that the predominant contribution of electrostatic forces to their bonding and their similar ionic radii renders difficult the specific separation of trivalent f-ions [17]. However, careful selection of ion-exchange resin and control of elution conditions may facilitate the separation of actinide from other radioisotopes.

Several studies reported methods for the separation and purification of actinium (Ac-225) using an ion-exchange resin-based extraction chromatographic system. [17, 22, 23]. In one study, a process was developed to separate Ac-225 from the bulk thorium target and co-produced fission products [24]. The study used cation-exchange resin (AG50) containing a sulfonic acid functional group, which would retain the actinium species. It has also been reported that thorium can be chelated to the citric acid and, therefore, it would not be retained by the resin [15].

### SUMMARY

According to aspects of the present disclosure, composite adsorbents for selectively separating actinium and radium from acidic solution and methods of using such composite adsorbents for selectively separating actinium and radium from acidic solution are provided. In the present method, porous metal-infused resins have been developed using phosphate recovered from waste buffer solution. Polyoxometalates (POM)-based mesoporous metal-infused resins may be prepared using modified sol-gel techniques. These mesoporous metal-infused resins may then be utilized for the separation and purification of radium and actinium from a mixture of fission-generated products.

In one embodiment, a polyoxometalate-based porous metal-infused ceramic resin comprising silica-coated composite antimony-vanadium oxide particles is utilized for selective adsorption of both actinium and radium from an acidic solution including other metal ions, such as thorium and barium. The acidic solution may be exposed to the antimony-vanadium resin through a batch or semi-batch process. Once the antimony-vanadium resin has reached adsorption capacity, the resin may be rinsed with an eluent comprising an acid rinsing solution to recover the adsorbed radium and actinium from the resin. The eluent preferably comprises nitric acid. The antimony-vanadium resin preferably does not have a substantial adsorption affinity for either thorium or barium.

In a second step, the solution containing the adsorbed actinium and radium recovered from the antimony-vanadium resin may then be exposed to a second resin comprising silica-coated composite metal oxide particles, which include calcium, phosphorus, manganese, vanadium, antimony, molybdenum, cerium, and tungsten. The second resin comprising composite metal oxide particles is utilized for selective adsorption of radium and generally does not have a substantial adsorption affinity for actinium. Once the second metal oxide resin has reached adsorption capacity, the resin may be rinsed with an eluent comprising an acid rinsing solution to recover the adsorbed radium from the resin. Thus, the effluent from the second step includes actinium, but a substantial portion of the radium has been separated from the effluent. The second metal oxide resin preferably also does not have a substantial adsorption affinity for barium.

In a third step, the effluent containing actinium may then be exposed to a third resin comprising composite titanium-tungsten oxide particles. The third resin is utilized for selective adsorption of metal ions from the acidic solution containing actinium and generally does not have a substantial adsorption affinity for either actinium or radium. The third titanium-tungsten oxide resin may have an adsorption affinity for the following metals: Cu, Pb, Zn, Co, Cr, Cd, Ni, Fe, Mn, Al, Ga, Ge, Sr, Be, Mg, Rb, Ba, Ce, Lu, and Zr. The third resin comprising composite titanium-tungsten oxide particles may be utilized as a finishing resin that selectively removes other metal ions to purify the actinium solution. In addition, the acidic solution containing adsorbed radium recovered from the second resin comprising composite metal oxide particles may also be separately exposed to the third resin comprising composite titanium-tungsten oxide particles to purify the radium solution. A waste effluent solution from the third step does not include substantial amounts of radium or actinium but may include any other metal ions present in the initial acidic solution.

The first resin comprising antimony-vanadium oxide particles may be prepared by first preparing an antimony solution and a vanadium solution. The antimony solution may be prepared by mixing an antimony salt, which is preferably antimony chloride, into an acid solution, which is preferably a concentrated hydrochloric acid (HCl) solution. The vanadium solution may be prepared by mixing a vanadium salt, which is preferably sodium metavanadate, into water. The vanadium solution may be combined with the antimony solution to form an antimony-vanadium solution. A surfactant solution may then be prepared by mixing a surfactant, which is preferably a non-ionic surfactant comprising Pluronic-123 triblock copolymer, into an alcohol, which is preferably ethanol. Next, a tetraethyl orthosilicate (TEOS) solution may be prepared by mixing TEOS into the surfactant solution. The TEOS solution may be combined with the antimony-vanadium solution to form a semi-solid gel, which may be allowed to age for a period of time to facilitate hydrolysis and polymerization processes. The semi-solid gel may then be heated to form the silica-coated composite antimony-vanadium oxide particles. The heating process facilitates the formation of solid composite clusters of the particulate material. The silica-coated composite antimony-vanadium oxide particles may then be calcined to produce the first resin.

The second resin comprising composite metal oxide particles may be prepared by first preparing a calcium-phosphate solution by mixing calcium and phosphate into an acid solution. The phosphate used for the calcium-phosphate solution may be recovered from a waste buffer solution by coagulation and flocculation of the waste buffer solution using ferric chloride and calcium hydroxide. Next, a molybdenum-tungsten solution may be prepared by mixing a molybdenum salt, which is preferably sodium molybdate, and mixing a tungsten salt, which is preferably sodium tungstate, into an acid solution, which is preferably phosphoric acid. Next, a manganese-cerium solution may be prepared by mixing a manganese salt, which is preferably manganese chloride (MnCl₂), and mixing a cerium salt, which is preferably cerium chloride (CeCl₂), into water. Next, an antimony solution may be prepared by mixing an antimony salt, which is preferably antimony chloride, into an acid solution, which is preferably a concentrated hydrochloric acid (HCl) solution, and a vanadium solution may be prepared by mixing a vanadium salt, which is preferably sodium metavanadate, into water. Next, a sol solution may be prepared by adding the molybdenum-tungsten solution, the manganese-cerium solution, the antimony solution, and the vanadium solution to the calcium-phosphate solution. A tetraethyl orthosilicate (TEOS) solution may then be prepared by mixing TEOS into an alcohol, which is preferably ethanol. The TEOS solution may be added to the sol solution to form a semi-solid gel, which may be allowed to age for a period of time to facilitate hydrolysis and polymerization processes. The semi-solid gel may then be heated to form silica-coated composite metal oxide particles. The heating process facilitates the formation of solid composite clusters of the particulate material. Next, the silica-coated composite metal oxide particles may be oxidized with an oxidizing solution. The oxidizing solution preferably comprises hydrogen peroxide, sodium hypochlorite, and sodium hydroxide. The silica-coated composite metal oxide particles are then separated from the oxidizing solution, dried, and calcined to produce the second resin.

The third resin comprising composite titanium-tungsten oxide particles may be prepared by first preparing a titanium solution by mixing titanium isopropoxide into an alcohol, which is preferably ethanol. Next, a tungsten solution may be prepared by dissolving tungsten into an acid solution, which is preferably phosphoric acid, and a tungsten-titanium solution may then be prepared by adding the tungsten solution to the titanium solution. Ethylene glycol is then added to the tungsten-titanium solution, which induces a complex reaction that forms a reaction product through polymerization of the reaction components (Ti, W, ethanol, and ethylene glycol). After the polymerization reaction, the product turned into a more viscous wet gel. The wet gel is dried to obtain a dried sample, and the dried sample is then heated. The heating process ensures that tungsten ions become entrapped within the pores of a titania network, thereby facilitating the formation of solid composite particulate material. Next, the composite titanium-tungsten oxide particles are oxidized with an oxidizing solution, which is preferably either hydrogen peroxide or sodium hypochlorite. The composite titanium-tungsten oxide particles are separated from the oxidizing solution, dried, and then calcined at a first temperature. The composite titanium-tungsten oxide particles are next calcined at a second temperature that is higher than the first temperature. After calcining, the composite titanium-tungsten oxide particles are soaked in a sodium acetate solution and then dried to obtain the third resin.

The foregoing summary has outlined some features of the biologically functional polynucleotide and method of production so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the biologically functional polynucleotide and method disclosed herein. Those skilled in the pertinent art should also realize that such equivalent designs or modifications do not depart from the scope of the biologically functional polynucleotide and method of the present disclosure.

### DESCRIPTION OF THE DRAWINGS

These and other features, aspects, and advantages of the present invention will become better understood with regard to the following description, appended claims, and accompanying drawings where:

FIG. 1 illustrates a schematic diagram showing a system for separation and purification of radium and actinium from a product of irradiated thorium target.

FIG. 2 illustrates a reaction mechanism for silica-coated porous antimony-vanadium oxide (SVS) particles.

FIG. 3 illustrates a chart illustrating the dynamic uptake of Ac-225 from a column packed with SVS resin from an acidic solution of 5M HNO₃ at a flow rate of 1 mL/minute.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Recovery of Phosphate from Waste Phosphate Buffer Solution

Contamination of surface water by phosphate (P) has received a great deal of attention due to eutrophication problems [25]. Various natural and anthropogenic activities contribute an excessive amount of organic and inorganic forms of phosphate in nature if the waste streams from such activities discharge directly into water bodies [26, 27]. Effluent discharges with even low concentrations of phosphates (<0.1 mg/L) have been reported to induce eutrophication [28]. Eutrophication has harmful effects on aquatic life, resulting in a reduction in biodiversity [29]. To control eutrophication, it is recommended that the total P in natural water bodies should not exceed 0.005-0.1 mg P/L [25, 29]. Therefore, phosphate should be removed from waste streams before discharge into the environment.

In radiopharmaceutical production, quality control (QC) is an important step to ensure radiochemical purity of the product. Phosphate buffer solution, in general, is used in some steps of QC processes to establish pharmaceutical and radioactive parameters of the final product [30]. In radiopharmaceutical industries, there is no major stream of wastewater associated with the QC process except that a small volume of waste phosphate buffer solution is generated due to QC activities. The present study examined the treatment of waste phosphate buffer solution from the QC steps of radiopharmaceutical activities by chemical coagulation and flocculation processes. The recovery of phosphate from the waste phosphate buffer solution from the QC laboratory was explored as a possible source of phosphate that can be used as an ingredient in the preparation of metal-infused composite resins.

### Experimental Section

### A. Wastewater Characterization

The chemical composition of waste buffer solution from the radiopharmaceutical QC laboratory was completely analyzed in this study using Inductive Couple Plasma (ICP)-mass spectroscopy. Supernatant samples after chemical coagulation and flocculation were also analyzed using ICP-mass spectroscopy.

### B. Chemical Coagulation And Analysis

Laboratory scale evaluation of chemical coagulation and flocculation was performed using a six-place jar test apparatus equipped with multi-speed mixing stirrers. The jar test procedure included high shear mixing at 100 rpm for 5 minutes, followed by 30 minutes of flocculation at 20 rpm, and 12 hours of settling sequence. Experiments were carried out with 150 ml of liquid in a jar. Supernatant was withdrawn at a height of 1.6 cm from the top using a hypodermic needle. At this depth, neither any floating particles were sucked in, nor was any sludge resuspended due to suction.

Ferric chloride and calcium hydroxide were used for flocculation and coagulation. First, the optimum pH for the function of ferric chloride was determined. Varying dosages of calcium hydroxide were then added at the optimum pH and ferric chloride dosage. Apart from this, mixing time, mixing speed, and mixer geometry were held constant to avoid the introduction of additional variables to the system. The clarification efficiencies were measured in terms of phosphate content in the solution. Once the optimum dosage of ferric chloride and calcium hydroxide had been determined, larger quantities of waste phosphate buffer solution were treated, and the supernatant was analyzed for phosphate, iron, and calcium present in the solution.

### C. Optimizing Chemical Dosage

Experiments were carried out to determine the combined optimum dosages of ferric chloride and calcium hydroxide. First, the optimum dosage of ferric chloride was determined. The coagulation and flocculation of the waste buffer solution was investigated using ferric chloride doses of 700 mg/L. To this, calcium hydroxide was added under vigorous stirring, and the pH was kept in the range of 9.0 to 9.5. Coagulated waste buffer samples were then allowed to settle overnight. The supernatant was separated from the suspended solids and tested for P, Fe, and Ca using the ICP-MS analyzer. The studies showed that a relatively low ferric chloride dosage of 700 mg/L and calcium hydroxide dosage of 10 gram/L could remove the phosphate load from the waste buffer solution by coagulation to an acceptable level. It is noted that the amount of phosphate in the waste buffer solution was approximately 19 gram/L. The amount of phosphate in the treated waste solution was in the range 0.0-0.05 mg/L. The solid that was separated from the supernatant was further dissolved completely in 40% hydrochloric acid (10 mL) under vigorous stirring at 70° C. (343K). The solution obtained in this step primarily comprises calcium and phosphate and is referred to herein as calcium-phosphate solution. The calcium-phosphate solution was then used for the preparation of metal-infused polyoxometalates (POM)-based resins.

### Preparation of Polyoxometalates (POMs)-Based Metal-Infused Resins: 2-Ra Resin, 3-Ra Resin, and SVS Resin

### A. Preparation of 2-Ra Resin Comprising Composite Metal Oxide Particles

Polyoxometalates or POMs are polyanionic aggregates of early transition metal oxides [31]. Polyoxometalates (POMs) mimic the reactivity of metal oxide surface as their ability to bind covalently functional groups [32]. A fully oxidized metal does not contain d electrons and can form strong bonds with π donor atoms such as oxygen [19]. The oxygen atoms donate electrons to the empty orbitals of metals creating a framework of strong metal oxide bonds. In this study, polyoxometalates (POMs)-based inorganic metal-oxide clusters are prepared in the presence of phosphate using metalloid and lanthanide metal ions along with various transition metals in their highest oxidation states. The preparation steps are as follows.

A solution of molybdenum and tungsten was prepared by mixing a calculated amount of sodium molybdate and sodium tungstate in 10 mL of 10% phosphoric acid (H₃PO₄). The solution of molybdenum and tungsten was then added to the above-mentioned calcium-phosphate solution dropwise under continuous stirring and heating at 70° C. (343K). To this, solutions of manganese chloride (MnCl₂) and cerium chloride (CeCl₂) are added dropwise to avoid precipitation.

In another embodiment, a calculated amount of antimony chloride (SbCl₃) was dissolved in 3 mL of 50% HCl solution and then added to the above molybdenum-tungsten solution. In another beaker, a calculated amount of sodium metavanadate was dissolved in 10 mL of deionized water under stirring at 70° C. using a water bath. The prepared vanadium solution was then added dropwise to the above mixture to form a metal ion solution. The metal ion solution was then mixed into the calcium-phosphate solution under continuous stirring at 70° C. using a water bath to obtain a clear sol solution. The atomic weight percentage of the mixture was P (21.64%), Sb (4.94%), V (6.92%), Mo (4.94%), Mn (8.56%), W (2.59%), Ce (3.36%), and Ca (47.05%). The sol solution is referred to herein as “P-sol.” To this P-sol, approximately 10 mL of 30% ammonium hydroxide (NH₄OH) was added and kept under stirring for 10 minutes to complete the reaction. The reaction mass was then allowed to settle overnight. The supernatant was separated from the suspended solids, and the solid was heated overnight at (343K) 70° C. in an oven. It was further heated in a furnace at (473K) 200° C. at a rate of 2° C./minute temperature increase and then kept for 4 hours, after which time it was left to cool down to room temperature. The obtained particles were then oxidized with 2% hydrogen peroxide (H₂O₂) for 2 to 4 hours under continuous slow stirring. After oxidation, the particles were then separated from the solution and washed several times (at least two times) with deionized water to remove any impurities present in the particles. The solid particles were then dried overnight at (343K) 70° C. to obtain solid composite particles. The composite samples were then calcined in a furnace at (723K) 450° C. The temperature increase in the furnace was maintained at a rate of 2° C./minute and then kept for 4 hours. Finally, the samples were cooled down to room temperature to obtain porous composite particles. This composite resin is referred to herein as “2-Ra resin.”

### B. Preparation of 3-Ra Resin Comprising Silica-Coated Composite Metal Oxide Particles

Several studies [32, 33, 34] have reported that the leaching of components from POM-based catalysts may occur under extreme reaction conditions, thereby causing loss of active sites and reactivity of the catalysts. At least one study reviewed the importance of porous silica as catalyst support [34]. The study reported that the immobilization of catalysts on a porous silica matrix shows high activity, low degree of leaching of metal, and easy recycling of catalyst material. In a review article, it was reported that the inclusion of certain POM-ions such as H₃PMo₁₂O₄₀, H₄SiW₁₂O₄₀, and H₃PW₆Mo₆O₄₀ with a silica matrix could not stop leaching of these acids from the silica matrix [32]. In one experiment, it was shown that the presence of orthophosphate may prevent the dissolution of metal ions in drinking water, thereby limiting the corrosion process in water pipe systems [35]. Thus, to overcome the problem of metal leaching, the present study explored whether the P-Sol-based POM cluster being crosslinked with porous silica matrix with the combined effect of phosphate and silica entrapping of POM may reduce the leaching of components from the POM clusters in the presence of highly acidic solution.

To this end, a ceramic resin comprising silica-coated composite metal oxide particles was prepared. This resin is referred to herein as “3-Ra resin.” The preparation procedure of 3-Ra resin was similar to the P-sol preparation process of the 2-Ra resin, but the P-Sol was further crosslinked with a porous silica matrix. The study explored whether the uniform distribution of POM particles in the silica matrix will improve mass transfer properties of the final resin product. Moreover, the combined effect of the phosphate in the P-Sol and the crosslinking of the P-Sol with a silica matrix may prevent metal dissolution from the POM-based resin in the presence of highly acidic solution conditions. To prepare the 3-Ra resin, approximately 4 mL of tetraethyl orthosilicate (TEOS) was mixed in 10 mL ethanol and then added dropwise to the P-sol under continuous stirring at 70° C. (343K). The TEOS was used in this step as a source of silica. It was assumed that the metal ion cluster composite in the P-sol can be further combined with silica without losing their synergistic properties. The mixture was kept under continuous gentle stirring and heating at 70° C. until a semi-solid gel was formed. The gel was further aged overnight at 323 K (50° C.) to facilitate the hydrolysis and polymerization processes. The semi-solid mass was further heated in a furnace at (473K) 200° C. at a rate of 1° C./minute temperature increase and then kept for 4 hours, at which time it was left to cool down to room temperature. This heating process facilitates the formation of solid composite clusters of the particulate material. Furthermore, it was envisaged that the modification of metal ions composite with silica may stabilize the clusters in their molecular form. The particulate material was further heated in a furnace at (473K) 200° C. at a rate of 2° C./minute temperature increase and then kept for 4 hours and then left to cool down to room temperature. The obtained particles were then oxidized with an oxidizing solution (1% H₂O₂+1.5% NaOCl+0.025M NaOH) for 2 to 4 hours under continuous slow stirring. After oxidation, the particles were then separated from the solution and washed several times (at least two times) with deionized water to remove any impurities present in the particles. The solid particles were then dried overnight at (343K) 70° C. to obtain solid composite particles. The composite samples were then calcined in a furnace at (723K) 450° C. The temperature increase in the furnace was maintained at a rate of 4° C./minute and then kept for 4 hours. Finally, the samples were cooled down to room temperature to obtain the silica-coated porous composite metal oxide particles of the 3-Ra resin.

### C. Synthesis of SVS Resin Comprising Silica-Coated Composite Antimony-Vanadium Oxide Nanoparticles

Vanadium and antimony composite nanoparticles were synthesized and coated in situ with porous, micro-structured silica using a modified sol-gel method for use as an adsorbent. This composite resin is referred to herein as “SVS resin.” The synthesis procedure involved three steps. In the first step, a calculated amount of antimony chloride was mixed thoroughly in 10 mL of 50% concentrated HCl under continuous stirring. In this step, a chemical reaction is not expected; only a homogeneous mixture is formed. In the second step, 0.88-grams of sodium metavanadate was mixed into water under continuous stirring at 70° C. using a water bath. Next, the vanadium solution from the second step was added dropwise to the antimony solution prepared in the first step under continuous stirring at 70° C. Special care was taken to avoid any precipitation while mixing the vanadium solution into the antimony solution from the first step. The reaction between Sb and V can be as follows:

SbCl₃+3NaVO₃→Sb(VO₃)₃+3NaCl (1)

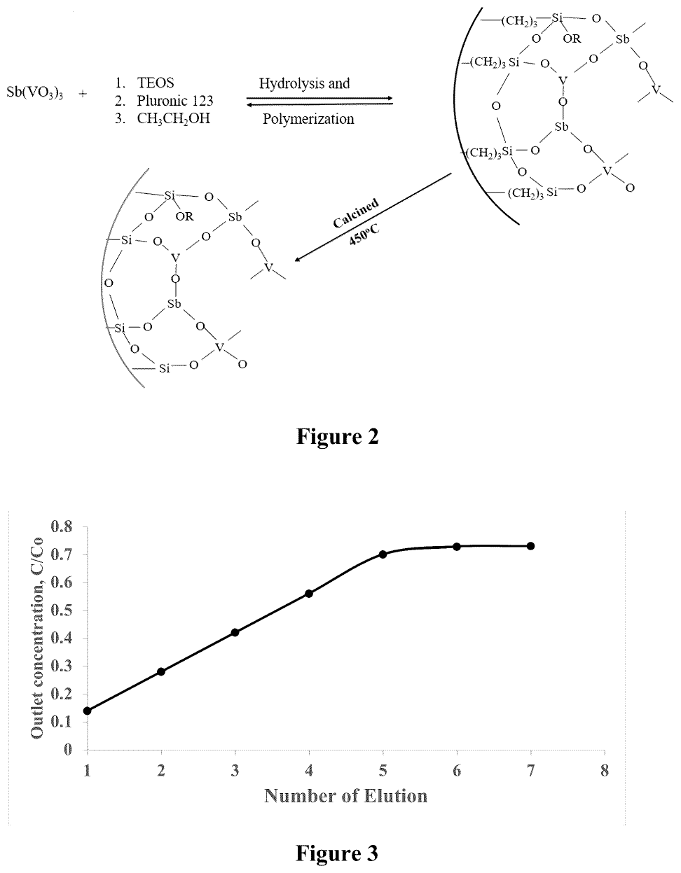

In the third step, a calculated amount of a non-ionic surfactant, which was triblock copolymer surfactant Pluronic-123 (EO20PO70EO20), was mixed thoroughly in 6.5-7.0 mL of ethanol under continuous sonication using a Cole Parmer 8820 sonic bath. To this, 2.5 mL of tetraethyl orthosilicate (TEOS) was added and mixed completely. The percentage of surfactant used to prepare the TEOS solution varied from 4% to 20% by weight. The TEOS solution was then added dropwise to the emulsified mixture of antimony and vanadium under continuous stirring at 70° C. using a water bath. The TEOS was used in this step as a source of silica. It was assumed that the antimony-vanadium composite can be further combined with silica without losing their synergistic properties. The mixture was kept under continuous gentle stirring and heating at 70° C. until a semi-solid gel was formed. The gel was further aged overnight at 313 K (40° C.) to facilitate the hydrolysis and polymerization processes. The semi-solid mass was further heated in a furnace at (473K-5233K) 200° C.-250° C. at a rate of 1° C./minute temperature increase and then kept for 4 hours and then left to cool down to room temperature. This heating process facilitates the formation of solid composite clusters of the particulate material. Furthermore, it was envisaged that the modification of vanadium and antimony composite nanoparticles with silica may stabilize the clusters in their molecular form. This phenomenon may stop leaching of the ingredients from the clusters in an acidic environment. FIG. 2 shows the possible reaction mechanism of silica-coated vanadium-antimonate particles. The composite particles were then washed thoroughly with deionized water to remove any contaminants. The sample was further dried in an oven at 323 K (50° C.) overnight. Finally, the product was calcined in a furnace at (723K) 450° C. at a rate of 4° C./minute temperature increase and then kept for 4 hours, resulting in the silica-coated vanadium-antimony oxide nanoparticles of the SVS resin.

### Preparation of Mesoporous Titanium-Tungsten (TW-2a) Composite Resin

In the present method, tungsten-doped mesoporous titanium composite material was prepared by the hydrolysis and condensation reaction of titanium alkoxide and tungsten in which aqueous organic media was used as a solution phase. In this method, amounts of titanium isopropoxide and tungsten salt solutions were vigorously mixed in 25 mL of ethanol under continuous stirring and heating at 70° C. (343K) as follows. This composite resin is referred to herein as “TW-2a resin.”

First, an amount of titanium isopropoxide was mixed with 25 mL of ethanol under continuous stirring and heating at 70° C. (343K). Under stirring, an amount of tungsten was dissolved in 10% of H₃PO₄ solution (10 mL) and it was added dropwise to the mixture. The molar ratio of titanium and tungsten was 0.985:0.015 in the mixture. The molar ratio of Ti and W were established based on trial and error. To this, at least 2 mL ethylene glycol was added as stabilizer and the solution was heated at (343K) 70° C. under continuous stirring for approximately three (3) hours. Under continuous stirring and heating, a complex reaction product was formed through the polymerization reaction between the reaction components (Ti, W, ethanol, and ethylene glycol). After the polymerization reaction, the product turned into a more viscous wet gel.

During the process of hydrolysis of titanium isopropoxide (TIP), it was assumed that tungsten ions were entrapped by a titania network and interacted with its internal surface hydroxyl groups of Ti (≡Ti OH), resulting in the (≡TiOH₂+)(H₂PW₁₂O₄₀⁻) compound [36]. It is also assumed that ethylene glycol inhibits precipitation of the metal ions, thus stabilizing the reaction process. Pore formation in the gel matrix is facilitated by the heat treatment in the furnace. The gel was further heated overnight at (343K) 70° C. in an oven. The dried sample was then heated in a furnace at (473K) 200° C. at a rate of 2° C./minute temperature increase and then kept for 4 hours and then left to cool down to room temperature. The heating process ensures that tungsten ions become entrapped within the pores of the titania network, thereby facilitating the formation of solid composite particulate material. The composite particulate material was then washed twice with deionized water. The sample of dried solid composite particulate material is referred to herein as “TW-1 particles” and is an intermediate product in the method for preparing the TW-2a resin. The TW-1 particles were then oxidized in either 1.5% NaOCl or 0.1M H₂O₂ solution at a pH of approximately 2 to 5 for a period of 2 to 4 hours under continuous slow stirring. After oxidation, the particles were then separated from the solution and washed several times with deionized water to remove any impurities present in the particles. The solid particles were then dried overnight at (343K) 70° C. to obtain solid composite particles.

It was observed in preliminary studies that the drying and calcination temperature has effects on the crystalline phase of the material. This phenomenon affects the crystallization pattern and characteristics of the final particulate material, which has direct effects on adsorption performance of the material. The sample of TW-1 particles was then calcined in a furnace at 823K (500° C.) to (873K) 600° C. at a rate of 4° C./minute temperature increase and then kept for 4 hours. The TW-1 sample was then left to cool down to room temperature to obtain tungsten-doped mesoporous TW-1 powder. The TW-1 sample was then calcined in a furnace at (1173K) 900° C. The temperature increase in the furnace was maintained at a rate of 10° C./minute and then kept for one (1) hour. Finally, the sample was cooled down to room temperature to obtain mesoporous TW-1 particles. The TW-1 particles were then washed using 0.05M HCl and then washed 2 to 3 times with deionized water until the solution became clear, and the particles were then dried at 70° C. overnight. Previous studies have shown that a small amount of tungsten leached out of the TW-1 particle composite structure upon acid washing. It is noted that H₃PO₄ was used during the preparation to acidify the titanium and tungsten solution. To stabilize the structure of the final composite, the TW-1 particles were further preconditioned with 1M acetate solution. In this case, the TW-1 particles were soaked in 1M sodium acetate solution overnight under continuous slow stirring. The particles were then separated from the acetate solution and then washed several times with deionized water. The solid particles were then dried overnight at (343K) 70° C. to obtain the solid composite titanium-tungsten oxide particles of the TW-2a resin. It was observed that the modification of the TW-1 particles with acetate solution reduced the release of tungsten from the titanium-tungsten (TW-2a) composite resin without compromising its adsorptive capacities for lanthanide elements from acidic solution.

### Experimental Procedure

The uptake of thorium, radium, and actinium onto the SVS resin, 2-Ra resin, and 3-Ra resin were carried out using batch studies, respectively. Typical batch study procedure for Ra-224 uptake is given as follows.

Equilibrium batch adsorption studies were carried out by exposing the resin to aqueous solutions of Ra-224 of 40 μCi concentrations in 100 mL Erlenmeyer flasks at room temperature (25° C.). About 50 mg of resin was added to 10 mL of Ra-224 solution. These amounts of resin and solution assured that an equilibrium condition was reached, i.e., all of the Ra-224 was not adsorbed by the resin. In one experiment, the pH of the solutions was adjusted by adding 0.1 mol/L nitric acid, and in another experiment, the performance of the resins was evaluated using Ra-224 in 1M HNO₃ acid solution. The flasks were placed in a constant temperature shaker bath for a specific time. Following the exposure of the resins to radium, the samples were collected at predetermined time intervals. The solutions were filtered, and the filtrates were analyzed for radium. The adsorption isotherm at a particular temperature was obtained by varying the initial concentration of radium ions. The amount of radium adsorbed per unit mass of adsorbent (qₑ) was calculated using the following equation:

$${q}_{e} ( μ Ci / g ) = ( {C}_{i} - {C}_{e} ) \times \frac{V}{g} \qquad ( 2 )$$

where Ci and Ce represent initial and equilibrium activity in μCi/L, respectively, v is the volume of the solution in liters (L), and g is the mass of the adsorbent in grams. The concentrations of Ra, Th, Ac, and Ba in the solution were measured using an Ortec GEM15-70 high purity germanium (HPGE) detector with DSpec LF digital signal processor. In the case of Ac-225, it was measured via its 221Fr daughter after at least one hour of ingrowth/decay.

### Results and Discussion

A. Ra-224 Uptake onto Various Resins

The adsorption of radium onto various resins is shown in Table 1 below.

TABLE 1
Radium-224 Uptake Onto Various Resins

| | | | | Radium-224 uptake (%) on to various resins | | | |
|---|---|---|---|---|---|---|---|
| | | | Exposure | at the following solution conditions: | | | |
| Resin ID | Isotope | S/L | time (hrs) | pH | (%) | Acidic | (%) |
| 2-Ra | Ra-224 | — | 16 | 2.5 | 94.5 | ~1M | 85.4 |
| 3-Ra | (40 μCi) | — | | 2.5 | 94.0 | HNO₃ | 80.8 |
| SVS | | — | | 2.5 | 93.7 | | 92.6 |

To study the effect of acidic pH on the uptake of Ra-224 on to resins, about 50 mg of resin was suspended in a vial containing Ra-224 with 40 μCi/10 mL. The experiments were carried out using batch techniques. The effectiveness of Ra-224 uptake was investigated using two sets of acidic solution as shown in Table 1. In one set of experiments, the pH of the Ra-224 solution was adjusted to ˜2.5 by addition of 0.1N HNO₃. In another set of experiments, Ra-224 solution was prepared using 1M HNO₃. The adsorption capacity of the resins and contact time were then studied. The uptake of Ra-224 from acidic solution (pH-2.5) by the resins increased with time. It was observed that significant adsorption occurred during the first 60 minutes of the run in most cases. An exposure time of 16 hours was used during batch studies to ensure that the equilibrium was attained. A similar trend was observed for the uptake of Ra-224 from 1M HNO₃. As can be seen from Table 1, the amount of Ra-224 uptake by 2-Ra, 3-Ra, and SVS resins at a pH of 2.5 were 94.5, 94.0, and 93.7%, respectively. The uptake of Ra-224 onto 2-Ra and 3-Ra resins slightly decreases in the presence of 1M HNO₃ compared to the uptake of Ra-224 from pH 2.5 solution (Table 1). However, the Ra-224 uptake capacity of SVS resin was similar from the 1M HNO₃ and the pH 2.5 solution. In another experiment, 2-Ra, 3-Ra, and SVS resins were exposed to 1000 mg/L Barium (Ba) in 5M HNO₃ solution. These experiments were carried out for 60 minutes following the batch technique mentioned earlier. It was observed that all three resins did not show any adsorption affinity for Ba from the HNO₃ (5M) solution.

B. Thorium Uptake onto Various Resins

In another experiment, thorium (Th) uptake onto various resins were also investigated. To study the effect of acidic pH on the uptake of thorium onto the resins, about 80 mg of resin was suspended in a vial containing 8 mL of 1000 mg/L thorium in different acid concentrations in solution. In one set of experiments, the acidic concentration of the thorium solution was adjusted to ˜1.1M, and in another set of experiments the thorium solution was adjusted to 7.5M using concentrated HNO₃. For these experiments, an exposure time of 1 hour was used during batch studies to ensure that equilibrium was attained. As can be seen from Table 2 below, the amount of thorium uptake by 2-Ra resin from the 1.1M and 7.5M HNO₃ solutions were 89.72, and 90.94%, respectively. However, the uptake of thorium on to oxidized 3-Ra resin in the presence of 1M HNO₃ was 92.62%, and it decreased to 33.8% in the presence of 7.5M HNO₃ (Table-2). Table 2 shows that the thorium uptake capacity of SVS resin was 4.62% at acidic concentration of 1.1M HNO₃. The uptake of thorium on SVS resin decreases to 0.98% in the presence of 7.5M HNO₃ compared to the uptake of thorium from 1.1M HNO₃.

TABLE 2
Thorium Uptake Onto Various Resins

| | | | Exposure | Thorium uptake (%) on to various resins | | | |
|---|---|---|---|---|---|---|---|
| | Thorium | S/L | time (hr) | at the following solution conditions: | | | |
| Resin ID | mg/L | mg/mL | hour | Acidic | (%) | Acidic | % |
| 3-Ra | 1000 | 80/8 | 1 | 1.1M | 89.72 | 7.5M | 90.94 |
| 3-Ra oxidized | | 80/8 | | HNO₃ | 92.62 | HNO₃ | 33.8 |
| SVS | | 80/8 | | | 4.62 | | 0.98 |

C. Ac-225 Uptake onto Various Resins

The adsorption of Ac-225 onto various resins is shown in Table 3 below.

TABLE 3
Ac-225 Uptake (%) Onto Various Composite
Resins From Acidic Solutions

| | | | Ac-225 uptake onto various resins at the | | | |
|---|---|---|---|---|---|---|
| | Ac-225 | Exposure | following solution conditions: | | | |
| | Activity | time | | Uptake | HNO₃ | Uptake |
| Resin | (μCi) | (Hours) | pH | (%) | conc. | (%) |
| 2-Ra | 30 | 4 | 3.5 | 69.7 | 5M | 3.5 |
| 3-Ra | | | 3.5 | 84.1 | 5M | 0.0 |
| SVS | | | 3.5 | 84.1 | 5M | 22.4 |

To study the effect of acidic pH on the uptake of Ac-225 onto the resins, about 50 mg of resin was suspended in a vial containing Ac-225 in 30 μCi/10 mL of solution. The experiments were carried out using batch techniques. In one set of experiments, the pH of the Ac-225 containing solution was adjusted to approximately 3.5 by addition of 0.1N HNO₃. In another set of experiments, an Ac-225 solution was prepared using 5M HNO₃. The adsorption capacity of the resins and contact time were then studied. The uptake of Ac-225 from acidic solution (pH of 3.5) by the resins increased with time. It was observed that significant adsorption occurred during the first 60 minutes of the run in most cases. An exposure time of 4 hours was used during batch studies to ensure that equilibrium was attained. A similar trend was observed for the uptake of Ac-225 from 5M HNO₃ solution. As can be seen from Table 3, the amount of Ac-225 uptake by 2-Ra, 3-Ra, and SVS resins at a pH of 3.5 were 69.7, 84.1, and 84.1%, respectively. Table 3 shows that the resin 3-Ra did not show a substantial adsorption affinity for Ac-225 from the 5M HNO₃ solution, and in fact showed negligible adsorption affinity for Ac-225, whereas the uptake of Ac-225 was 3.5 and 22.4% by the 2-Ra resin and SVS resin, respectively. Therefore, SVS resin was used to investigate the effect of acid concentration on Ac-225 uptake.

In this experiment, about 200 mg of SVS resin was suspended in a vial containing Ac-225 in 10 mL of HNO₃ solution. The concentration of nitric acid and Ac-225 in the solution are shown in Table 4 below.

TABLE 4
Ac-225 Uptake Onto SVS Resin in Different
Concentrations of HNO₃ Solution

| HNO₃ Acid | | |
|---|---|---|
| Concentration in | Initial Activity of Ac-225 | Ac-225 uptake onto resin |
| solution (M) | in Solution (μCi) | from the solution (%) |
| 0.1 | 116.9 | 87% |
| 1 | 112 | 89% |
| 3 | 116.4 | 89% |
| 5 | 111.1 | 89% |

It was observed that significant adsorption occurred during the first 60 minutes of the run in most cases. An exposure time of 4 hours was used during batch studies to ensure that equilibrium was attained. Table 4 shows that the Ac-225 uptake on to SVS resin is independent of acid concentration in the solution. The uptake of Ac-225 on SVS resin was found to be approximately 89% from more than 110 μCi in the HNO₃ solution with concentrations ranging from 0.1M to 5M.

D. Dynamic Study for Ac-225 Uptake onto SVS Resin

In dynamic adsorption of metal ions on an adsorbent solid, the solution of sorbate (Ac-225) is passed through the column containing adsorbent. For instance, an all-glass column was used to study the adsorption of Ac-225 under dynamic conditions. Approximately 200 mg of resin was used to make a 1-cm³ column. The bed volume is calculated from the expression:

$$Bed volume = π {r}^{2} h \qquad ( 3 )$$

where r is the radius of the column, and h is the bed height. The influent solution is allowed to pass through the bed at a predetermined constant flow rate during a run. An influent sample solution of 10 mL of 5M HNO₃ was prepared with approximately 40 μCi of Ac-225. In this case, the inlet concentration of the Ac-225 solution was approximately 4.0 μCi/mL, and the flow rate was 1.0 mL/min through the bed. The samples at the bed outlet were collected at alternating one-minute intervals to estimate the amount of Ac-225 retained by the column. It was observed that the bed appeared to be saturated after approximately 7 minutes, as indicated by the outlet Actinium-225 concentration. It was observed that approximately 73% of 40 μCi of Ac-225 was retained by the column, as shown in FIG. 3, which illustrates a chart indicating the dynamic uptake of Ac-225 from a column packed with SVS resin from an acidic solution of 5M HNO₃ at a flow rate of 1 mL/minute.

It was observed that Ac-225 broke through the column rather quickly. By adjusting the bed volume or the amount of the resin in the bed, the breakthrough time can be increased to recover a substantial amount of Ac-225 from the radioactive solution.

E. Removal of Ac-225 from Multicomponent Mixture Using TW-2a Resin

Fission generated Ac-225 often contains various types of by-product isotopes. A typical simulant was prepared with Ac-225 solution, and calculated amounts of multi-components such as Cu, Pb, Zn, Co, Cr, Cd, Ni, Fe, Mn, Al, Ga, Ge, Sr, Be, Mg, Rb, Ba, Ce, Lu and Zr were added to the solution. A sufficient amount of deionized water was added to adjust the solution to 5M HNO₃ solution in a volumetric flask. The concentration of each component in the mixture was approximately 50 mg/L. Aliquots of the mixture were spiked with Ac-225 solution of known concentration. The concentration of Ac-225 was approximately 30 μCi/10 mL of the simulant. The adsorption capacity of Ac-225 from the simulant on TW-2a resin was studied using a batch process. To study the effectiveness of TW-2a resin for the uptake of Ac-225, about 100 mg of resin was suspended in a vial containing prepared simulant. An exposure time of 4 hours was used during batch studies to ensure that equilibrium was attained. It was observed that the resin TW-2a shows greater adsorption affinity for other components from the simulant than Ac-225. The uptake of Ac-225 on the Tw-2a resin was almost negligible. The experiments were carried out twice with the results calculated as an average of the values. From these results, it was observed that the TW-2a resin is capable of adsorbing most of the given cationic metal ions from the simulant except actinium and radium. Therefore, it was determined that the TW-2a resin can be used for final polishing steps for the actinium and radium separation and purification process.

### F. Cation Exchange Columns for Ac-225 Separation And Purification

From the batch study, it was observed that SVS resin shows negligible adsorption affinity for thorium from strong HNO₃ solution. However, a substantial amount of Ac-225 and Ra-224 was absorbed on SVS resin from the 5M HNO₃ solution. In the case of the 3-Ra resin, it shows strong adsorption affinity for Ra-224 but did not show substantial adsorption affinity for Ac-225 from the 5M HNO₃ solution. Finally, the TW-2a resin did not show any substantial adsorption affinity for either Ac-225 or Ra-224, but the TW-2a resin showed strong adsorption affinity for most of the cationic metal ions from the 5M HNO₃ solution. Thus, it was determined that the SVS resin, 3-Ra, resin, and TW-2a resin can be used in combination for the separation and purification of Ac-225 and Ra-224 from the thorium target solution.

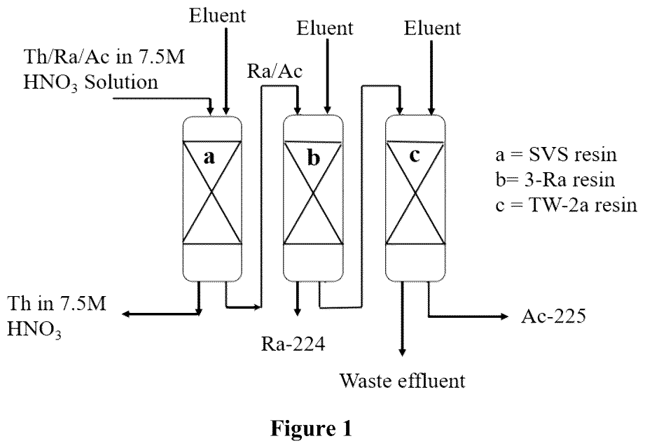

FIG. 1 shows a system for the selective separation of actinium and radium isotopes from irradiated bulk thorium targets. In this system, three columns may be utilized in succession for the separation of radium and actinium from a proton irradiated Th-232 matrix in 7.5 to 8.0M HNO₃. Based on the present study, it was determined that a column containing SVS resin could be used to adsorb both radium and actinium from the thorium matrix. In this step, approximately >99.9% of the thorium (Th) by activity can be rejected from the column as an effluent. Following rinsing steps with an eluent to remove residual thorium, actinium and radium may be recovered from the column containing SVS resin using a specific concentration of HNO₃ solution as a rinsing solution. Further separations of actinium via 3-Ra and TW-2a resins may yield a purer form of actinium, while the column with TW-2a will provide additional decontamination from thorium and other spallation byproducts.

### CONCLUSION

The separation and purification of actinium and radium from the irradiated product of target materials is still underdeveloped. The present study has been carried out in several steps. In the first step, phosphate has been recovered from the waste buffer solution and then used as one of the ingredients for the preparation of metal-infused resin. In addition, polyoxometalates (POM)-based microporous metal-infused resins such as SVS resin, 3-Ra resin, and TW-2a resin are prepared using sol-gel techniques. The performances of these micro-porous metal-infused resins are evaluated for the separation and purification of radium and actinium from the products of irradiated (fission generated) thorium targets.

Based on the observed data, the coated SVS micro-porous adsorbent is capable of selective separation of both radium and actinium isotopes from bulk Th-232 target material. In addition, batch studies data show that the 3-Ra resin adsorbed almost 90% of 40 μCi of Ra-224 from 1M HNO₃ solution but did not show substantial adsorption affinity for Ac-225. In fact, the adsorption affinity of the 3-Ra resin for Ac-225 was negligible. The 3-Ra resin was generally found to be preferable to the 2-Ra resin because the 2-Ra resin showed greater adsorption affinity for Ac-225 than the negligible affinity exhibited by the 3-Ra resin, and the 3-Ra also exhibited a very low degree of leaching of metal. Batch studies were also carried out for the adsorption of barium and thorium onto SVS and 3-Ra resins. It was observed that neither the SVS resin nor the 3-Ra resin showed any substantial adsorption affinity for thorium and barium from a solution containing 1000 mg/L Ba and Th in 1M HNO₃ solution. In another experiment, the TW-2a resin was exposed to a proton-irradiated thorium target simulant. Results show that the TW-2a resin uptakes most of the given cationic metal ions from the simulant except actinium and radium. Therefore, it was determined that this TW-2a resin can be used as final polishing steps for the actinium and radium separation and purification process.

### REFERENCES

The following references, to the extent that they provide exemplary procedural or other details supplementary to those set forth herein, are specifically incorporated herein in their entirety by express reference thereto:
1. Thiele, N. A., and Wilson, J. J. Actinium-225 for Targeted a Therapy: Coordination Chemistry and Current Chelation Approaches, CANCER BIOTHERAPY AND RADIOPHARMACEUTICALS, Volume 33, Number 8, 2018, DOI: 10.1089/cbr.2018.2494.
2. Technical meeting on Alpha emitting radionuclides and radiopharmaceuticals for therapy, Jun. 24-28, 2013, IAEA Headquarters, Vienna, Austria.
3. Radchenko, V., Engle, J. W., Wilson, J. J. et al. (2015) Application of ion exchange and extraction chromatography to the separation of actinium from proton-irradiated thorium metal for analytical purposes, Journal of Chromatography A, Vol 1380, 6 Feb. 2015, Pages 55-63.
4. Radchenko, V., Morgenstern, A., Amir, R. et al (2021), Production and Supply of a-Particle-Emitting Radionuclides for Targeted a-Therapy, J Nucl Med 2021; 62:1495-1503, DOI: 10.2967/jnumed.120.261016.
5. Kim, Y-S., and Brechbiel, M. W., An overview of targeted alpha therapy, Tumour Biol. 2012 June; 33(3): 573-590. doi:10.1007/s13277-011-0286-y.
6. Nagatsu, K., Suzuki, H., Fukuda, M., et al. (2021), Cyclotron production of 225Ac from an electroplated 226Ra target, European Journal of Nuclear Medicine and Molecular Imaging (2021) 49:279-289.
7. Tafreshi, N. K., Doligalski, M. L., and Tichacek, C. J., (2019) Development of Targeted Alpha Particle Therapy for Solid Tumors, Molecules 2019, 24, 4314; doi:10.3390/molecules24234314.
8. Pouget, J-P., and Constanzo, J., (2021) Revisiting the radiobiology of targeted alpha therapy, Fron. Med. 8: 692436.doi:10.3389/fmed.2021.692436.
9. Bannik, K., Madas, B., and Jarzombek, M., Radiobiological effects of the alpha emitter Ra-223 on tumor cells, Scientific Reports |(2019) 9:18489 https://doi.org/10.1038/s41598-019-54884-7.
10. Fitzsimmons, J., Foley, B., Torre, B. et al., Optimization of Cation Exchange for the Separation of Actinium-225 from Radioactive Thorium, Radium-223 and Other Metals, Molecules 2019, 24, 1921; doi:10.3390/molecules24101921.
11. Melville, G. J., and Allen, B. Cyclotron and linac production of Ac-225. Appl. Radiat. Isotopes (2009), doi:10.1016/j.apradiso.2008.11.012.
12. Hatcher-Lamarre, J. L., Sanders, V. A., Rahman, M., et al. Alpha Emitting Nuclides for Targeted Therapy, Nucl Med Biol. 2021 January; 92: 228-240. doi:10.1016/j. nucmedbio.2020.08.004.
13. Eychenne, R., C Chdrel, M.; Haddad, F.; Gudrard, F.; Gestin, J.-F. Overview of the Most Promising Radionuclides for Targeted Alpha Therapy: The “Hopeful Eight”. Pharmaceutics 2021, 13, 906. https://doi.org/10.3390/pharmaceutics13060906.
14. Camacaro, J. F., Dunckley, C. P., et al (2023), Development of Ac-225 production from low isotopic dilution Th-229, ACS Omega 2023, 8, 38822-38827.
15. Fitzsimmons, J., Griswold, J., Medvedev, D., et al., Defining Processing Times for Accelerator Produced 225Ac and Other Isotopes from Proton Irradiated Thorium, Molecules 2019, 24, 1095; doi:10.3390/molecules24061095.
16. Hasan, S., and Prelas, M. A., Molybdenum-99 production pathways and the sorbents for 99Mo/99mTc generator systems using (n, 7) 99Mo: a review, SN Applied Sciences (2020) 2:1782.
17. Knight, A. W., Chiarizia, R., and Soderholm, L. Extraction selectivity Selectivity of a Quaternary Alkylammonium Salt for Trivalent Actinides over Trivalent Lanthanides: Extraction Does Extractant Aggregation Play a Role?, Solvent Extraction and Ion Exchange, DOI: 10.1080/07366299.2017.1326770.
18. Robertson, A. K. H. et al., Development of 225Ac Radiopharmaceuticals: TRIUMF Perspectives and Experiences, Current Radiopharmaceuticals, 2018, 11, 156-172.
19. Hatcher, J. L., “Fundamental chemistry related to the separations and coordination of Actinium-225, Thorium-227, and Technetium-99” (2018). CUNY Academic Works. https://academicworks.cuny.edu/gc_etds/2891.
20. Thiele, N. A., and Wilson, J. J. Actinium-225 for Targeted a Therapy: Coordination Chemistry and Current Chelation Approaches, CANCER BIOTHERAPY AND RADIOPHARMACEUTICALS Volume 33, Number 8, 2018 DOI: 10.1089/cbr.2018.2494.
21. Müller, C., van der Meulen, N. P., Bene sovi, M. et al. Therapeutic Radiometals Beyond 177Lu and 90Y: Production and Application of Promising a-Particle, b2-Particle, and Auger Electron Emitters, J Nucl Med 2017; 58:91S-96S, doi: 10.2967/jnumed.116.186825.
22. Radchenko, V., Mastren, T., Meyer, C. A. L., et al. Radiometric Evaluation of Diglycolamide Resins for the Chromatographic Separation of Actinium from Fission Product Lanthanides, Talanta, Volume 175, 2017, Pages 318-324, http://dx.doi.org/10.1016/j.talanta.2017.07.057.
23. Mastren, T., Radchenko, V., Hopkins, P. D. et al., (2017), Separation of 103Ru from a proton irradiated thorium matrix: A potential source of Auger therapy radionuclide 103 mRh. PLoS ONE 12(12): e0190308. https://doi.org/10.1371/journal.pone.0190308.
24. McAlister, D. R., and Horwitz, E. P., Selective separation of radium and actinium from bulk thorium target material on strong acid cation exchange resin from sulfate media, Applied Radiation and Isotopes 140 (2018) 18-23.
25. Banu, H. A., T., Karthikeyan, P., and Meenakshi, S., Removal of nitrate and phosphate ions from aqueous solution using zirconium encapsulated chitosan quaternized beads: Preparation, characterization and mechanistic performance, Results in Surfaces and Interfaces 3 (2021) 100010, https://doi.org/10.1016/j.rsurfi.2021.100010.
26. Sena, M., Seib, M., Niguera, D. R. et al., Environmental impacts of phosphorus recovery through struvite precipitation in wastewater treatment, Journal of Cleaner Production, Volume 280, Part 1, 20 Jan. 2021, 124222, https://doi.org/10.1016/j.jclepro.2020.124222.
27. Curan, D. T., (2015) “Phosphate Removal and Recovery from Wastewater by Natural Materials for Ecologically Engineered Wastewater Treatment Systems” (2015). Graduate College Dissertations and Theses. 455. https://scholarworks.uvm.edu/graddis/455.
28. Ayoub, G. M., Kalinian, H., Zayyat, R., Efficient phosphate removal from contaminated water using functional raw dolomite powder, SN Applied Sciences (2019) 1:802 https://doi.org/10.1007/s42452-019-0833-5.
29. Nur, T., Johir, M. A. H., and Loganathan, P. et al. (2014) Phosphate removal from water using an iron oxide impregnated strong base anion exchange resin, Journal of Industrial and Engineering Chemistry, Volume 20, Issue 4, 25 Jul. 2014, Pages 1301-1307.
30. Molavipordanjani, S., and Hosseinimehr, S. J., Fundamental concepts of radiopharmaceuticals quality controls, Pharm Biomed Res, 2018, 4(3); 1-8, DOI: 10.18502/pbr.v413.538.
31. Humelnicu, D., Olariu, R-I., Sandu, I., et al., Studies on Chemical Interferences on Uranium (VI) and Thorium (IV) Reaction with (iso)polyoxometalates, (Bucuresti) 60 (12), 2009, http://www.revistadechimie.ro REV. CHIM.
32. Dufaud, V., and Lefebvre, F., Inorganic Hybrid Materials with Encapsulated Polyoxometalates, Materials 2010, 3, 682-703; doi:10.3390/ma3010682.
33. Otor, H. O., Steiner, J. B., Garcia-Sancho, C. et al. Encapsulation Methods for Control of Catalyst Deactivation: A Review, ACS Catal. 2020, 10, 7630-7656. https://dx.doi.org/10.1021/acscatal.0c01569.
34. Shende, P. S., Suryawanshi, P. S., Patil, K. K. et al., A Brief Overview of Recent Progress in Porous Silica as Catalyst Supports. J. Compos. Sci. 2021, 5, 75. https://doi.org/10.3390/jcs5030075.
35. Rosales E, Del Olmo G, Calero Preciado C and Douterelo I (2020) Phosphate Dosing in Drinking Water Distribution Systems Promotes Changes in Biofilm Structure and Functional Genetic Diversity. Front. Microbiol. 11:599091. doi: 10.3389/fmicb.2020.599091.
36. Yanga, Y., Wuc, Q., Guo, Y. et al., Efficient degradation of dye pollutants on nanoporous polyoxotungstate-anatase composite under visible-light irradiation, Journal of Molecular Catalysis A: Chemical 225 (2005) 203-212.

What is claimed is:

1. A method for separating actinium and radium from acidic solution, said method comprising the steps of:
preparing a first resin, wherein the first resin is a polyoxometalate-based porous metal-infused ceramic resin comprising silica-coated composite antimony-vanadium oxide particles; and
exposing a first acidic solution comprising actinium and radium to the first resin so that the first resin selectively adsorbs the actinium and radium from the first acidic solution.

2. The method of claim 1, further comprising the steps of:
rinsing the first resin with a first rinsing solution to recover adsorbed actinium and radium from the first resin to create a second acidic solution comprising the actinium and radium recovered from the first resin;
preparing a second resin, wherein the second resin is a polyoxometalate-based porous metal-infused ceramic resin comprising silica-coated composite metal oxide particles, wherein the composite metal oxide particles comprise calcium, phosphorus, manganese, vanadium, antimony, molybdenum, cerium, and tungsten; and
exposing the second acidic solution to the second resin so that the second resin selectively adsorbs radium from the second acidic solution, wherein the second resin does not have a substantial adsorption affinity for actinium.

3. The method of claim 2, wherein the step of exposing the second acidic solution to the second resin creates a third acidic solution, wherein a substantial portion of radium present in the second acidic solution is not present in the third acidic solution, wherein the method further comprises the steps of:
rinsing the second resin with a second rinsing solution to recover adsorbed radium from the second resin, thereby creating a fourth acidic solution comprising the radium recovered from the second resin;
preparing a third resin, wherein the third resin is a polyoxometalate-based porous metal-infused resin comprising composite titanium-tungsten oxide particles; and
exposing the third acidic solution to the third resin so that the third resin selectively adsorbs metal ions from the third acidic solution, wherein the third resin does not have a substantial adsorption affinity for actinium or radium.

4. The method of claim 3, further comprising the step of exposing the fourth acidic solution to the third resin so that the third resin selectively adsorbs metal ions from the fourth acidic solution.

5. The method of claim 3, wherein the third resin has an adsorption affinity for Cu, Pb, Zn, Co, Cr, Cd, Ni, Fe, Mn, Al, Ga, Ge, Sr, Be, Mg, Rb, Ba, Ce, Lu, and Zr.

6. The method of claim 1, wherein the first resin does not have a substantial adsorption affinity for thorium.

7. The method of claim 2, wherein neither the first resin nor the second resin has a substantial adsorption affinity for barium.

8. The method of claim 1, wherein the step of preparing the first resin comprises the steps of:
preparing an antimony solution by mixing an antimony salt into an acid solution;
preparing a vanadium solution by mixing a vanadium salt into water;
adding the vanadium solution to the antimony solution to form an antimony-vanadium solution;
preparing a surfactant solution by mixing a surfactant into an alcohol;
preparing a tetraethyl orthosilicate (TEOS) solution by mixing TEOS into the surfactant solution;
adding the TEOS solution to the antimony-vanadium solution to form a semi-solid gel;
heating the semi-solid gel to form the silica-coated composite antimony-vanadium oxide particles; and
calcining the silica-coated composite antimony-vanadium oxide particles to obtain the first resin.

9. The method of claim 8, wherein the surfactant is a non-ionic surfactant comprising Pluronic-123 triblock copolymer.

10. The method of claim 8, wherein the antimony salt is antimony chloride, and wherein the acid solution comprises hydrochloric acid.

11. The method of claim 8, wherein the vanadium salt is sodium metavanadate.

12. The method of claim 2, wherein the step of preparing the second resin comprises the steps of:
preparing a calcium-phosphate solution by mixing calcium and phosphate into an acid solution;
preparing a molybdenum-tungsten solution by mixing a molybdenum salt and a tungsten salt into an acid solution;
preparing a manganese-cerium solution by mixing a manganese salt and a cerium salt into water;
preparing an antimony solution by mixing an antimony salt into an acid solution;
preparing a vanadium solution by mixing a vanadium salt into water;
preparing a sol solution by adding the molybdenum-tungsten solution, the manganese-cerium solution, the antimony solution, and the vanadium solution to the calcium-phosphate solution;
preparing a tetraethyl orthosilicate (TEOS) solution by mixing TEOS into an alcohol;
adding the TEOS solution to the sol solution to form a semi-solid gel;
heating the semi-solid gel to form silica-coated composite metal oxide particles;
oxidizing the silica-coated composite metal oxide particles with an oxidizing solution;
separating the silica-coated composite metal oxide particles from the oxidizing solution and drying the silica-coated composite metal oxide particles; and
calcining the silica-coated composite metal oxide particles to obtain the second resin.

13. The method of claim 12, wherein the oxidizing solution comprises hydrogen peroxide, sodium hypochlorite, and sodium hydroxide.

14. The method of claim 12, wherein the step of preparing the calcium-phosphate solution comprises recovering phosphate from a waste buffer solution by coagulation and flocculation of the waste buffer solution using ferric chloride and calcium hydroxide.

15. The method of claim 12, wherein the antimony salt is antimony chloride, and wherein the vanadium salt is sodium metavanadate.

16. The method of claim 3, wherein the step of preparing the third resin comprises the steps of:
preparing a titanium solution by mixing titanium isopropoxide into an alcohol;
preparing a tungsten solution by dissolving tungsten into an acid solution;
preparing a tungsten-titanium solution by adding the tungsten solution to the titanium solution;
adding ethylene glycol to the tungsten-titanium solution to induce a polymerization reaction that forms a wet gel;
drying the wet gel to obtain a dried sample and then heating the dried sample to entrap tungsten ions in pores of a titania network, thereby forming the composite titanium-tungsten oxide particles;
oxidizing the composite titanium-tungsten oxide particles with an oxidizing solution;
separating the composite titanium-tungsten oxide particles from the oxidizing solution and drying the composite titanium-tungsten oxide particles;
calcining the composite titanium-tungsten oxide particles at a first temperature;
calcining the composite titanium-tungsten oxide particles at a second temperature that is higher than the first temperature;
soaking the composite titanium-tungsten oxide particles in a sodium acetate solution; and
drying the composite titanium-tungsten oxide particles to obtain the third resin.

17. A polyoxometalate-based porous metal-infused ceramic resin comprising silica-coated composite antimony-vanadium oxide particles.
